(19) United States
(12) Patent Application Publication
(10) Pub. No.: US 2020/0238730 A1
(43) Pub. Date: Jul. 30, 2020

(54) IMAGE FORMING APPARATUS AND IMAGE FORMING METHOD

(71) Applicant: Konica Minolta, Inc., Tokyo (JP)

(72) Inventors: Hajime KAWAKAMI, Tokyo (JP); Yusuke MAMIYA, Nagoya-shi (JP); Yusuke NISHISAKA, Tokyo (JP); Shinya TOKUTAKE, Okazaki-shi (JP)

(21) Appl. No.: 16/727,098

(22) Filed: Dec. 26, 2019

(30) Foreign Application Priority Data
Jan. 24, 2019 (JP) 2019-010655

(51) Int. Cl. B41J 11/00

(52) U.S. Cl. CPC B41J 11/0015

(57) ABSTRACT

An image forming apparatus includes: a drop applier that applies a drop to a surface of a coating layer formed on a surface of a recording medium; a viscosity improver that improves viscosity of the drop on the surface of the coating layer; and a roller that rolls the drop improved in viscosity, wherein the drop at a time of rolling has lower viscosity than the coating layer.

The entire disclosure of Japanese patent Application No. 2019-010655, filed on Jan. 24, 2019, is incorporated herein by reference in its entirety.

### BACKGROUND

### Technological Field

The present invention relates to an image forming apparatus and an image forming method. More specifically, the present invention relates to an image forming apparatus and an image forming method that successfully enable expansion of a drop and enable good fixability of the drop on a recording medium by rolling the drop applied to the recording medium.

### Description of the Related Art

An image forming apparatus (for example, an ink jet printer) that forms an image with drops controls a diameter of a drop (ink drop) on a recording medium so as to curb consumption of the drops and to reduce a feeling of relief (feeling of irregularities).

In an image forming apparatus disclosed in JP 63-205241 A, a hot melt ink is used, and ink drops are allowed to penetrate into a recording medium by heating or pressing, or by heating and pressing.

In an image forming apparatus disclosed in JP 5-169649 A, a hot melt ink is used, and ink drops are expanded on an intermediate transfer body by heating or pressing so as to transfer the ink drops to a recording medium.

The technique disclosed in JP 63-205241 A is intended to achieve fixability of an ink on a recording medium and is not intended to expand ink drops. This technique allows ink drops cooled on a recording medium to penetration into the recording medium by heating or pressing so as to control the degree of penetration by, for example, high-precision temperature control. However, with this technique, expansion of the ink drops cannot be controlled. Furthermore, depending on a state of the recording medium, the ink penetrates into the recording medium to a large extent, and even if the ink drops are pressed, the ink drops cannot be expanded.

In the technique disclosed in JP 5-169649 A, ink drops (liquid) are expanded on an intermediate transfer body by heating or pressing so as to transfer the ink drops to a recording medium. In this technique, sizes and shapes of the transferred ink drops vary depending on whether the intermediate transfer body and the recording medium are in contact with each other and on surface shapes (irregularities) of the recording medium. Therefore, it is difficult to control expansion of the ink drops on the recording medium. Since the ink drops transferred to the recording medium are reversed, surfaces of the ink drops are not pressed, and the surfaces are affected by a surface shape (for example, porous shape) of the intermediate transfer body. Accordingly, the surfaces may deteriorate in evenness and glossiness or may increase a feeling of relief.

### SUMMARY

Accordingly, an object of the present invention is to provide an image forming apparatus and an image forming method that successfully enable expansion of a drop and enable good fixability of the drop on a recording medium by rolling the drop applied to the recording medium.

Other objects of the present invention will be disclosed in the following description.

To achieve at least one of the abovementioned objects, according to an aspect of the present invention, an image forming apparatus reflecting one aspect of the present invention comprises: a drop applier that applies a drop to a surface of a coating layer formed on a surface of a recording medium; a viscosity improver that improves viscosity of the drop on the surface of the coating layer; and a roller that rolls the drop improved in viscosity, wherein the drop at a time of rolling has lower viscosity than the coating layer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a side view showing a configuration of an image forming apparatus according to a first embodiment;

FIG. 2 is a side view showing a configuration of an image forming apparatus that does not form a coating layer;

FIG. 3 is a side view showing rolling of a drop on a recording medium without a coating layer;

FIG. 4 is a side view showing a drop rolled on a recording medium provided with a coating layer that has viscosity lower than that of the drop;

FIG. 5 is a side view showing a drop rolled on a recording medium provided with a coating layer that has viscosity higher than that of the drop (side view showing a penetration force into the coating layer);

FIG. 6 is a side view showing a drop rolled on a recording medium provided with a coating layer that has viscosity higher than that of the drop (side view showing a penetration force into the recording medium);

FIGS. 7A and 7B are a cross-sectional view and a plan view, respectively, each showing a relation between viscosity of a drop and a shape of the drop after rolling;

FIG. 8 is a graph showing a relation between a complex viscosity of a drop and an amount of light irradiated to the drop by a viscosity improver;

FIG. 9 is a block diagram showing a recording control device of the image forming apparatus according to the first embodiment;

FIG. 10 is a side view showing a configuration of an image forming apparatus according to a second embodiment;

FIG. 11 is a side view showing rolling of a drop on a recording medium provided with a coating layer in a region where the drop is to be applied;

FIG. 12 is a side view showing a relation between volumes of a coating layer formed in a region where a drop is to be applied and the drop; and

FIG. 13 is a flowchart showing performance of an image forming apparatus of a third embodiment.

### DETAILED DESCRIPTION OF EMBODIMENTS

Hereinafter, an image forming apparatus according to one or more embodiments of the present invention will be described with reference to the drawings. An image forming method according to an embodiment of the present invention is embodied as performance of the image forming apparatus. Accordingly, the image forming method will be described as performance of the image forming apparatus. However, the scope of the invention is not limited to the disclosed embodiments. In the following description, parts having the same function and configuration are denoted by the same reference numerals and description thereof may be omitted.

### First Embodiment

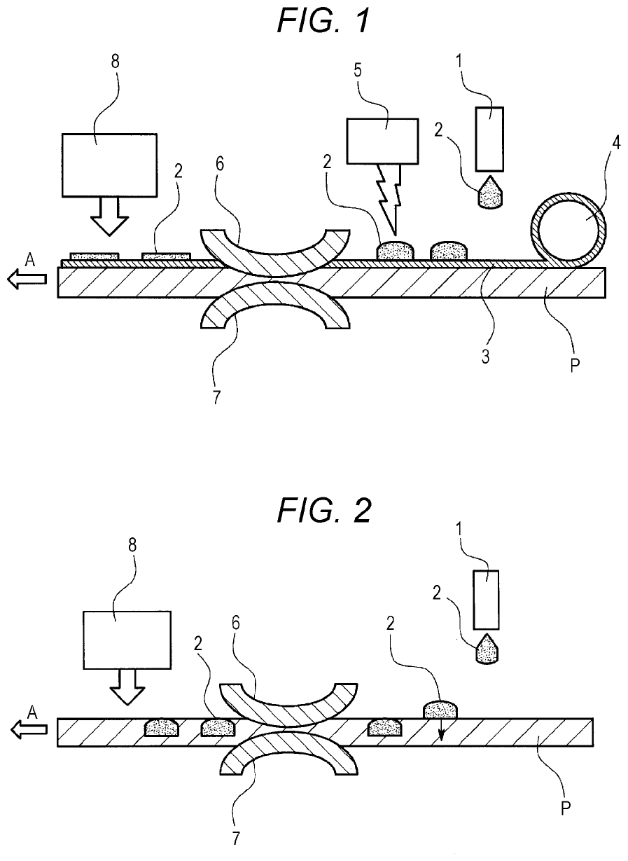

FIG. 1 is a side view showing a configuration of an image forming apparatus according to a first embodiment.

The image forming apparatus according to the embodiment includes a conveyor that conveys a recording medium P as illustrated in FIG. 1. The conveyor conveys the recording medium P with a conveyor belt (not shown) in the direction of arrow A in the drawing.

This image forming apparatus includes a drop ejection head 1 serving as a drop applier. Based on image data, the drop ejection head 1 ejects a drop 2 and applies the drop 2 to a surface of a coating layer 3 formed on a surface of the recording medium P so as to form an image.

In this embodiment, an ink drop are used as the drop. The drop ejection head 1 includes a yellow ink head, a magenta ink head, a cyan ink head, and a black ink head. The drop ejection head 1 preferably forms color images. Note that the number of heads and the number of colors included in the drop ejection head 1 are not limited at all.

The drop ejection head 1 may employ known methods such as drop-on-demand and continuous inkjet. Examples of a method for ejecting an ink include electromechanical conversion of single cavity type, double cavity type, bender type, piston type, shear mode type, and shared wall type; electrothermal conversion of thermal ink jet type and bubble jet (registered trademark) type; and electrostatic attraction of spark jet type.

This image forming apparatus includes a coating roller 4 serving as a coating layer former. The coating roller 4 forms the coating layer 3 on the surface (image forming surface) of the recording medium P. The coating roller 4 is a roller supported by a shaft and having a length that covers the full width of the recording medium P. A coating material is supplied to a peripheral surface of the coating roller 4. The coating roller 4 rolls to bring the peripheral surface into contact with the surface of the recording medium P. Accordingly, the coating material is applied to the surface of the recording medium P, leading to formation of the coating layer 3. Before the drop 2 is applied, the coating roller 4 forms the coating layer 3 at least in a region where the drop 2 is to be applied by the drop ejection head 1. In this embodiment, the coating roller 4 forms the coating layer 3 on the entire surface of the recording medium P.

The coating layer 3 former is not particularly limited and may employ, for example, a coating bar (bar coater) and a drop ejection head (inkjet head) as well as the coating roller 4 (roll coater).

In this embodiment, the drop ejection head 1 and the recording medium P are moved relative to each other by conveying the recording medium P. However, the drop ejection head 1 and the coating roller 4 may be operated to move relative to the recording medium P.

The coating layer 3 is not limited to one formed by a coating layer former such as the coating roller 4 and may be what is called a pre-coating layer formed by an industrial production method as part of a production process of the recording medium P. In such a case, the image forming apparatus does not require a coating layer former.

The coating material that forms the coating layer 3 preferably has high viscosity. The reason is that high-viscosity coating material prevents the drop 2 from penetrating into the coating layer 3 as described later. It is preferable to use a coating material made of a high-molecular-weight material that is not easily affected by liquid penetration. An example of the material include a liquid that has a molecular weight of several thousand or more and contains a photopolymerizable compound. Examples of the photopolymerizable compound include a radical polymerizable compound and a cationic polymerizable compound. The photopolymerizable compound may be any of a monomer, a polymerizable oligomer, a prepolymer, or a mixture thereof.

The radical polymerizable compound is preferably an unsaturated carboxylic acid ester compound, and more preferably (meth)acrylates. In this specification, note that “(meth)acrylates” represent acrylates or methacrylates, “(meth)acryl” represents acryl or methacryl, and “(meth)acryloyl” represents acryloyl or methacryloyl.

Examples of monofunctional (meth)acrylates include isoamyl (meth)acrylate, stearyl (meth)acrylate, lauryl (meth)acrylate, octyl (meth)acrylate, decyl (meth)acrylate, isomylstil (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinic acid, 2-(meth)acryloyloxyethyl phthalic acid, 2-(meth)acryloyloxyethyl-2-hydroxyethyl-phthalic acid, and t-butylcyclohexyl (meth)acrylate.

Examples of polyfunctional (meth)acrylates include bifunctional (meth)acrylates such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A PO adduct di(meth)acrylate, hydroxypivalate neopentyl glycol di(meth)acrylate, polytetramethylene glycol di(meth)acrylate, polyethylene glycol diacrylate, and tripropylene glycol diacrylate; and tri- or higher functional (meth)acrylates such as trimethylolpropane tri (meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerine propoxy tri(meth)acrylate, and pentaerythritol ethoxy tetra(meth)acrylate.

The radical polymerizable compound preferably contains (meth)acrylates modified with ethylene oxide or propylene oxide (hereinafter simply referred to as “modified (meth)acrylates”). Modified (meth)acrylates are more photosensitive. In addition, modified (meth)acrylates are more compatible with other components even at high temperatures. Furthermore, since modified (meth)acrylates have little cure shrinkage, modified (meth)acrylates are less likely to cause curling of printed matters during actinic irradiation.

Examples of the cationic polymerizable compound include epoxy compounds, vinyl ether compounds, and oxetane compounds.

An amount of photopolymerizable compound contained in the coating material is, for example, 1.0 mass % or more and 97 mass % or less, and preferably 30 mass % or more and 90 mass % or less, of the total mass of the coating material.

The coating material may further contain a photopolymerization initiator. Any photopolymerization initiator may be used as long as it initiates polymerization of a photopolymerizable compound. For example, in a case where the coating material contains a radical polymerizable compound, the photopolymerization initiator may be a photoradical initiator, and in a case where the coating material contains a cationic polymerizable compound, the photopolymerization initiator may be a photocationic initiator (photo-acid generator).

An amount of photopolymerization initiator may be set to any value within a range where the coating material starts curing by actinic irradiation. For example, the amount is 0.1 mass % or more and 20 mass % or less, and preferably 1.0 mass % or more and 12 mass % or less, of the total mass of the coating material. When the coating material starts curing without a photopolymerization initiator, that is, for example, when the coating material is semi-cured by electron beam irradiation, a photopolymerization initiator is unnecessary.

Alternatively, the coating material may be a liquid containing a surfactant and a liquid component such as water and a water-soluble organic solvent, or may be a liquid having low surface tension such as silicone oil. The coating material may contain, for example, a polyvalent metallic ion and a polyvalent organic acid, or a component that deposits or aggregates a coloring material contained in the drop 2. These components deposit or aggregate the coloring material in the drop 2 so as to further stabilize a diameter of a dot formed by the drop 2.

The drop 2 employed in the image forming apparatus is not particularly limited and may be a normal ink used for image formation by the drop ejection head 1. For example, the drop 2 is obtained by dispersing a coloring material in a liquid medium. Known additives such as a surfactant or a dispersant may be mixed in the drop 2 as necessary. In addition, a phase change ink and an ultraviolet (UV) curable ink are also preferably employed. After landing on the recording medium P, the phase change ink causes a phase change according to a temperature of the recording medium P and improves the viscosity of the phase change ink. Furthermore, a liquid-liquid reaction ink that causes a phase change by a reaction with the coating layer 3 may also be employed.

Examples of the coloring material include dyes and pigments. From a viewpoint of forming a good weather-resistant image, the coloring material is preferably a pigment. The pigment can be selected from, for example, a yellow pigment, a red or magenta pigment, a blue or cyan pigment, and a black pigment according to a color of an image to be formed.

The drop 2 may contain a coloring material such as a dye and a pigment, a dispersant for dispersing a pigment, a fixing resin for fixing a pigment to the coating layer 3, a surfactant, a polymerization inhibitor, an ultraviolet absorber, and a gelling agent that causes sol-gel phase transition of the drop 2 by temperature changes. The drop 2 may contain one of these components, or may contain two or more of these components.

All that the dispersant requires is to disperse a pigment sufficiently. Examples of the dispersant include a hydroxyl group-containing carboxylic acid ester, salts of a long-chain polyaminoamide and a high-molecular weight acid ester, a salt of a high-molecular weight polycarboxylic acid, salts of a long-chain polyaminoamide and a polar acid ester, a high-molecular weight unsaturated acid ester, polymer copolymer, modified polyurethane, modified polyacrylate, a polyether ester anionic activator, naphthalene sulfonic acid formalin condensate salt, aromatic sulfonic acid formalin condensate salt, polyoxyethylene alkyl phosphate ester, polyoxyethylene nonylphenyl ether, and stearylamine acetate.

An amount of dispersant is, for example, 20 mass % or more and 70 mass % or less of the total mass of the pigment.

Examples of the fixing resin include (meth)acrylic resins, epoxy resins, polysiloxane resins, maleic acid resins, vinyl resins, polyamide resins, nitrocellulose, cellulose acetate, ethyl cellulose, ethylene-vinyl acetate copolymers, urethane resins, polyesters resins, and alkyd resins.

An amount of fixing resin is, for example, 10 mass % or more and 10.0 mass % or less of the total mass of the drop 2. Since particles become amorphous and form a self-film, substantially, the drop 2 does not need to contain a fixing resin.

Examples of the surfactant include anionic surfactants such as dialkyl sulfosuccinates, alkyl naphthalene sulfonates, and fatty acid salts; nonionic surfactants such as polyoxyethylene alkyl ethers, polyoxyethylene alkyl allyl ethers, acetylene glycols, and polyoxy ethylene/polyoxypropylene block copolymers; cationic surfactants such as alkylamine salts and quaternary ammonium salts; silicone surfactants; and fluorosurfactants.

An amount of surfactant is preferably 0.001 mass % or more and less than 5.0 mass % of the total mass of the drop 2.

Examples of the gelling agent include ketone wax, ester wax, petroleum wax, vegetable wax, animal wax, mineral wax, hydrogenated castor oil, modified wax, higher fatty acids, higher alcohols, hydroxystearic acids, fatty acid amides such as N-substituted fatty acid amides and specific fatty acid amides, higher amines, esters of sucrose fatty acids, synthetic waxes, dibenzylidene sorbitol, dimer acids, and dimer diols. Among these examples, ketone wax, ester wax, higher fatty acids, higher alcohols, and fatty acid amides are preferable from a viewpoint of further improving the pinning property of the drop 2. More preferable examples are ketone wax or ester wax having 9 to 25 carbon atoms in carbon chains arranged on both sides of the keto group or the ester group.

An amount of gelling agent is preferably 1.0 mass % or more and 10.0 mass % or less of the total mass of the drop 2.

A medium for the drop 2 may be either an aqueous medium or an oleaginous medium. In a case where the drop 2 is a water-based liquid, the drop 2 can contain water and can optionally contain a water-soluble organic solvent. Furthermore, in a case where the drop 2 is a solvent-based liquid, the drop 2 can contain an organic solvent. Still further, in a case where the drop 2 is an actinic ray curable liquid, the drop 2 can contain a photopolymerizable compound that polymerizes and crosslinks by actinic irradiation, and optionally contains a photopolymerization initiator.

When the drop 2 is a water-based liquid, examples of the water-soluble organic solvent include alcohols such as methanol, ethanol, propanol, isopropanol, butanol, isobutanol, sec-butanol, and t-butanol; glycerin such as ethylene glycol, diethylene glycol, triethylene glycol, polyethylene glycol, propylene glycol, dipropylene glycol, polypropylene glycol, butylene glycol, hexanediol, and pentanediol; polyhydric alcohols such as hexanetriol, thiodiglycol, 1,2-butanediol, 1,3-butanediol, 1,2-pentanediol, 1,2-hexanediol, and 1,2-heptanediol; amines such as ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, and tetramethylpropylenediamine; amides such as formamide, N, N-dimethylformamide, and N, N-dimethylacetamide; heterocyclic compounds such as 2-pyrrolidone, N-methyl-2-pyrrolidone, cyclohexyl pyrrolidone, 2-oxazolidone, and 1,3-dimethyl-2-imidazolidinone; sulfoxides such as dimethyl sulfoxide; and glycol ethers such as ethylene glycol monomethyl ether, ethylene glycol monoethyl ether, ethylene glycol monobutyl ether, ethylene glycol diethyl ether, ethylene glycol dimethyl ether, diethylene glycol monomethyl ether, diethylene glycol monoethyl ether, diethylene glycol monobutyl ether, diethylene glycol ethyl methyl ether, diethylene glycol dimethyl ether, diethylene glycol diethyl ether, diethylene glycol dibutyl ether, propylene glycol monomethyl ether, propylene glycol monoethyl ether, propylene glycol monobutyl ether, dipropylene glycol monomethyl ether, dipropylene glycol monoethyl ether, propylene glycol dimethyl ether, dipropylene glycol dimethyl ether, propylene glycol diethyl ether, dipropylene glycol diethyl ether, ethylene glycol monomethyl acetate, ethylene glycol monoethyl acetate, ethylene glycol monobutyl acetate, diethylene glycol monomethyl acetate, ethylene glycol monomethyl ether acetate, ethylene glycol monoethyl ether acetate, ethylene glycol monobutyl ether acetate, propylene glycol monomethyl ether acetate, propylene glycol monoethyl ether acetate, diethylene glycol monoethyl acetate, diethylene glycol monobutyl acetate, and triethylene glycol monobutyl ether.

When the drop 2 is a water-based liquid, an amount of water-soluble organic solvent is, for example, 5.0 mass % or more and 30 mass % or less of the total mass of the drop 2.

When the drop 2 is a solvent-based liquid, examples of the organic solvent include a water-soluble organic solvent and a water-insoluble organic solvent that are used for a water-based liquid.

Examples of the water-insoluble organic solvent include aliphatic hydrocarbons having 5 to 15 carbon atoms such as pentane, hexane, i-hexane, heptane, i-heptane, octane, and i-octane; alicyclic hydrocarbons having 5 to 15 carbon atoms such as cyclopentane, cyclohexane, methylcyclohexane, dimethylcyclohexane, ethylcyclohexane, cycloheptane, and cyclooctane; cyclic unsaturated hydrocarbons having 5 to 15 carbon atoms such as cyclohexene, cycloheptene, cyclooctene, 1,1,3,5,7-cyclooctatetraene, and cyclododecene; aromatic hydrocarbons having 6 to 12 carbon atoms such as benzene, toluene, ethylbenzene, cumene, o-xylene, m-xylene, and p-xylene; monovalent alcohols having 5 to 15 carbon atoms such as heptanol, hexanol, methyl hexanol, ethyl hexanol, heptanol, octanol, decanol, undecyl alcohol, and lauryl alcohol; alicyclic ketones having 5 to 15 carbon atoms such as methyl-i-butyl ketone, di-i-butyl ketone, cyclohexanone, methylcyclohexanone, cycloheptanone, and cyclooctanone; ester compounds such as methyl acetate, ethyl acetate, propyl acetate, i-propyl-acetate, butyl acetate, hexyl acetate, amyl acetate, i-amyl acetate, 2-ethylhexyl acetate, methyl propionate, ethyl propionate, butyl propionate, hexyl propionate, amyl propionate, ethyl valerate, ethyl hexanoate, ethyl heptanoate, ethyl octoate, ethyl decanoate, cyclohexyl acetate, cyclooctyl acetate, phenyl acetate, phenyl propionate, methyl benzoate, ethyl benzoate, butyl benzoate, dimethyl phthalate, diethyl phthalate, and dibutyl phthalate; nitro compounds such as nitroethane, nitropropane, nitropentane, nitrobenzene, dinitrobenzene, nitrotoluene, and nitroxylene; nitriles such as acetonitrile and benzonitrile; and lactones such as γ-butyrolactone and ε-caprolactone.

When the drop 2 is a solvent-based liquid, an amount of water-insoluble organic solvent is, for example, 1.0 mass % or more and 98 mass % or less, preferably 20 mass % or more and 95 mass % or less, and more preferably 40 mass % or more and 90 mass % or less, of the total mass of the drop 2.

When the drop 2 is an actinic ray curable liquid, examples of the photopolymerizable compound include the compounds enumerated as examples of the coating material. The photopolymerizable compound may be any of a monomer, a polymerizable oligomer, a prepolymer, or a mixture thereof.

When the drop 2 is an actinic ray curable liquid, an amount of photopolymerizable compound is, for example, 1.0 mass % or more and 97 mass % or less, and preferably 30 mass % or more and 90 mass % or less, of the total mass of the drop 2.

When the drop 2 is an actinic ray curable liquid, the photopolymerization initiator only has to be any one that initiates polymerization of a photopolymerizable compound. For example, in a case where the drop 2 contains a radical polymerizable compound, the photopolymerization initiator may be a photoradical initiator, and in a case where the drop 2 contains a cationic polymerizable compound, the photopolymerization initiator may be a photocationic initiator (photo-acid generator).

An amount of photopolymerization initiator may be set to any value as long as the drop 2 is sufficiently cured by actinic irradiation and does not deteriorate in ejecting property. For example, an amount of photopolymerization initiator may be 0.1 mass % or more and 20 mass % or less, and preferably 1.0 mass % or more and 12 mass % or less, of the total mass of the drop 2. When the drop 2 is sufficiently cured without a photopolymerization initiator, that is, for example, when the drop 2 is cured by electron beam irradiation, a photopolymerization initiator is unnecessary.

This image forming apparatus includes a viscosity improver 5 that improves viscosity of the drop 2 on the surface of the coating layer 3. The viscosity improver 5 improves viscosity of the drop 2 by, for example, actinic irradiation, heating, or heat absorption according to properties of the drop 2 (ink).

Examples of actinic rays include ultraviolet rays (UV), electron beams, α-rays, γ-rays, and X-rays. From a viewpoint of safety and a viewpoint of the ability in polymerization and crosslinking with a small amount of energy, ultraviolet rays or electron beams are preferable as the actinic rays. Alternatively, viscosity of the drop 2 may be improved by removing a liquid component contained in the drop 2 by volatilization with heat or the like. Among those examples, actinic irradiation is more preferable in that actinic rays enables short-time viscosity improvement and reduces an amount of volatile organic compounds (VOC) to be generated.

This image forming apparatus includes a rolling roller 6 and a counter roller 7 which are rollers for rolling the drop 2 that has viscosity improved. The rolling roller 6 and the counter roller 7 roll the drop 2 with pressure or heat, or with pressure and heat. The rolling roller 6 and the counter roller 7 are rollers supported by a shaft and having a length that covers the full width of the recording medium P. The rolling roller 6 rolls to bring its peripheral surface into contact with the surface of the recording medium P, and the counter roller 7 rolls to bring its peripheral surface into contact with the back surface of the recording medium P. Accordingly, the rolling roller 6 and the counter roller 7 sandwich the recording medium P. The rolling roller 6 and the counter roller 7 are biased toward each other to apply pressure to the recording medium P. Alternatively, the rolling roller 6 and the counter roller 7 are heated by a heater to heat the recording medium P or to heat the recording medium P while applying pressure thereto.

When the drop 2 is rolled by the rolling roller 6, a diameter of an interface between the drop 2 and the coating layer 3 (a diameter of the drop 2 on the surface of the coating layer 3) increases to, for example, 105 to 130%. The rolled drop 2 is cured or dried by a curing or drying tool 8 according to properties of the drop 2 (ink) and is fixed on the coating layer 3.

The following formula expresses the penetration of the drop 2 into the recording medium P when the coating layer 3 is not formed.

### [Formula 1]

### Basic Theoretical Formula of Penetration

$$l = \sqrt{\frac{r γcosθ}{2 η} t} ( Lucas \text{-} Washburn Equation )$$

$$l \text{:} Penetration depth$$

$$r \text{:} Capillary diameter$$

$$γ \text{:} Surface tension of liquid$$

$$θ \text{:} Contact angle$$

$$η \text{:} Viscosity$$

$$t \text{:} Time$$

Even though the drop 2 has high viscosity (η), if the coating layer 3 is not formed, a large capillary radius (r) of the recording medium P or a large surface tension (γ) of the drop 2 at the time of landing increases a penetration depth (l) and makes the drop 2 easier to penetrate into the recording medium P. The recording medium P has a porous structure with a large number of capillaries. The penetration of the drop 2 depends on sizes and distribution of capillary holes. The larger the pore diameter, the more the drop 2 is likely to penetrate into the recording medium P. With viscosity at the time of landing, the drop 2 penetrates into plain paper. An average radius of capillary holes of plain paper is about 0.6 μm.

Hereinafter, in comparison with a case where the coating layer 3 is not formed, effects of the coating layer 3 will be described with reference to FIGS. 2 to 6.

FIG. 2 is a side view showing a configuration of an image forming apparatus that does not form a coating layer.

As shown in FIG. 2, when the coating layer 3 is not formed, the drop 2 penetrates into the recording medium P fast, and it is difficult to improve the viscosity of the drop 2 before the drop 2 penetrates into the recording medium P. That is why the drop 2 penetrates into the recording medium P. In order to eject the drop 2 from the drop ejection head 1 successfully, the viscosity of the drop 2 should not be improved inside the drop ejection head 1 before ejection. Furthermore, since actinic rays may hit a nozzle surface of the drop ejection head 1, it is difficult to improve the viscosity when the drop 2 is ejected (before landing) In this manner, when the coating layer 3 is not formed on the recording medium P, the drop 2 penetrates into the recording medium P.

When using the recording medium P that easily allows the drop 2 to penetrate, the drop 2 penetrates into the recording medium P upon landing, which makes it difficult to expand the drop 2 even by rolling. Even when using the recording medium P into which the drop 2 is less likely to penetrate, it is difficult to control expansion of the drop 2 because the degree of penetration of the drop 2 varies depending on the recording medium P.

FIG. 3 is a side view showing rolling of a drop on a recording medium without a coating layer.

As shown in FIG. 3, the drop 2 has higher viscosity upon landing than upon ejection. However, even with the recording medium P into which the drop 2 is less likely to penetrate, when the coating layer 3 is not on the recording medium P, rolling the drop 2 increases a penetration force F2 into the recording medium P. The large penetration force F2 accelerates the penetration into the recording medium P and relatively reduces a force F1 for spreading the drop 2 on the surface of the recording medium P (F2>F1).

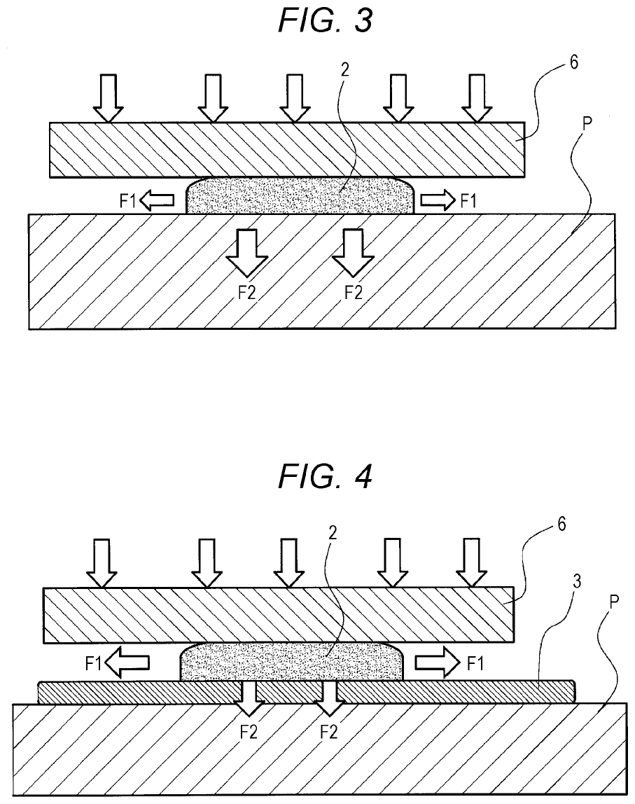

FIG. 4 is a side view showing a drop rolled on a recording medium provided with a coating layer that has viscosity lower than that of the drop.

Even though the coating layer 3 is formed, if the drop 2 has higher viscosity than the coating layer 3, the penetration force F2 of the drop 2 into the coating layer 3 is large as shown in FIG. 4, and the force F1 for spreading the drop 2 on the surface of the coating layer 3 is relatively small. Accordingly, the drop 2 landed on the surface of the coating layer 3 easily penetrates into the coating layer 3. When the drop 2 penetrates into the coating layer 3, the drop 2 tends to vary in diameter.

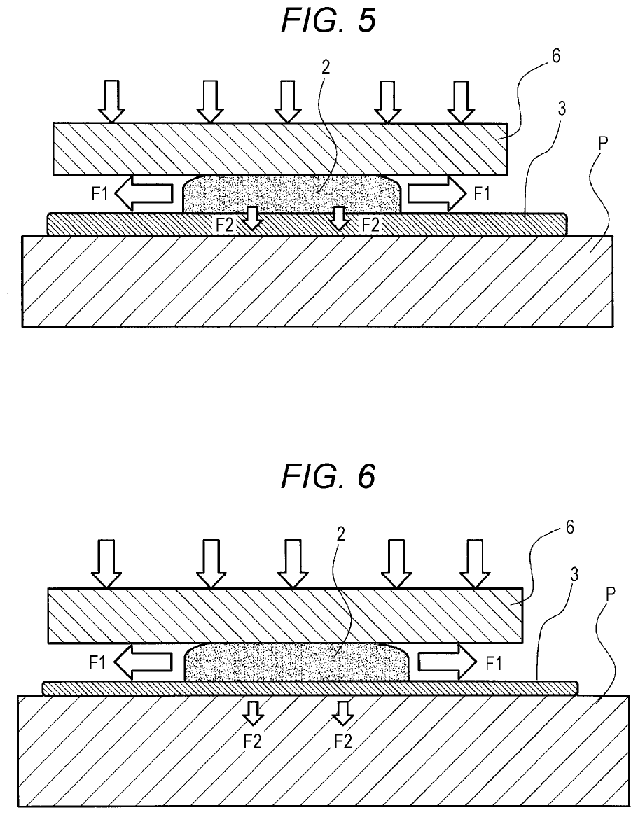

FIG. 5 is a side view showing a drop rolled on a recording medium provided with a coating layer that has viscosity higher than that of the drop (side view showing a penetration force into the coating layer).

In this image forming apparatus, when the drop 2 is rolled by the rolling roller 6 and the counter roller 7, the drop 2 has lower viscosity than the coating layer 3. If the drop 2 has lower viscosity than the coating layer 3, as shown in FIG. 5, the penetration force F2 of the drop 2 into the coating layer 3 becomes small, and the force F1 for spreading the drop 2 on the surface of the coating layer 3 becomes relatively large (F1>F2).

FIG. 6 is a side view showing a drop rolled on a recording medium provided with a coating layer that has viscosity higher than that of the drop (side view showing a penetration force into the recording medium).

If the drop 2 has lower viscosity than the coating layer 3, as shown in FIG. 6, the penetration force F2 of the drop 2 into the coating layer 3 becomes small, which controls the penetration of the drop 2 into the recording medium P. Accordingly, the drop 2 can be expanded on the surface of the coating layer 3.

In this manner, the drop 2 having lower viscosity than the coating layer 3 makes it possible to expand the drop 2 successfully on the surface of the coating layer 3.

In this image forming apparatus, since the coating layer 3 has higher viscosity than the drop 2, it is possible to stabilize the surface shape of the coating layer 3 and to prevent scattering of the shape of the landed drop 2. Furthermore, since the drop 2 is less likely to penetrate into the coating layer 3, it is possible to prevent the drop 2 from varying in diameter. Furthermore, in this image forming apparatus, since the coating layer 3 has higher viscosity than the drop 2, it is possible to prevent the drop 2 from penetrating into the coating layer 3 after landing of the drop 2 on the coating layer 3. At the same time, it is possible to expand the drop 2 by rolling after improving the viscosity of the drop 2 appropriately.

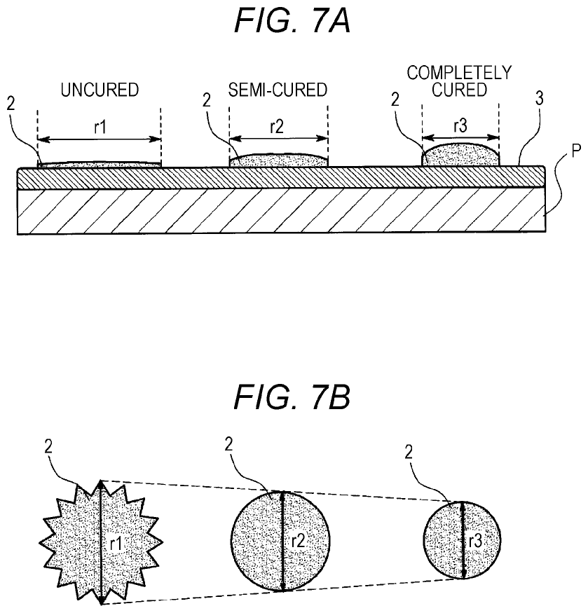

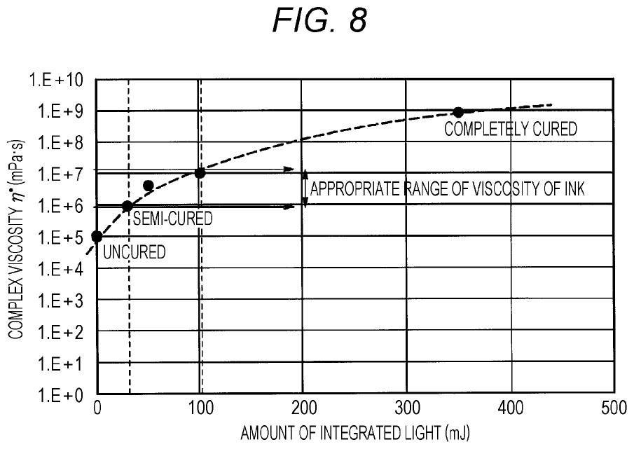

Hereinafter, a preferable range of the viscosity of the drop 2 will be described with reference to FIGS. 7A to 8.

FIGS. 7A and 7B are a cross-sectional view and a plan view, respectively, each showing a relation between viscosity of a drop and a shape of the drop after rolling.

If the drop 2 at the time of rolling has too high viscosity (completely cured), as shown on the right side of FIGS. 7A and 7B, the drop 2 spreads on the surface of coating layer 3 insufficiently, and a diameter r3 of the drop 2 hardly increases.

Furthermore, if the drop 2 at the time of rolling has too low viscosity (uncured), as shown on the left side of FIGS. 7A and 7B, the drop 2 expands on the surface of the coating layer 3 but crushes into a radial shape (star shape), which makes it difficult to form a circular drop 2.

If the drop 2 at the time of rolling has an appropriate viscosity (semi-cured), as shown in the middle of FIGS. 7A and 7B, the drop 2 spreads on the surface of coating layer 3 with its circular shape maintained, and a diameter r1 of the drop 2 increases sufficiently.

FIG. 8 is a graph showing a relation between a complex viscosity η* of a drop and an amount of light irradiated to the drop by a viscosity improver.

The drop 2 at the time of rolling preferably has a complex viscosity η* of 1.0×10⁶ to 1.0×10⁷ (mPa·s) as shown in FIG. 8. Here, an amount of light (amount of integrated light) irradiated to the drop 2 by the viscosity improver 5 is, for example, 30 to 100 (mJ), and the drop 2 is in a semi-cured state.

The viscosity and phase transition temperature of the drop 2 and the coating layer 3 can be obtained by measuring temperature changes of the dynamic viscoelasticity of the drop 2 and the coating layer 3 with a rheometer. In this specification, these viscosity and phase transition temperature are values obtained by the following method. The drop 2 and the coating layer 3 are heated to 100° C. While viscosities of the drop 2 and the coating layer 3 are measured with a stress-controlled rheometer (Anton Paar, Physica MCR301 (cone plate diameter: 75 mm, cone angle: 1.0 degree)), the drop 2 and the coating layer 3 are cooled to 20° C. at a shear rate of 11.7 (1/s) and a rate of temperature fall of 0.1° C./s, whereby obtaining a viscosity/temperature curve. Viscosity at 40° C. and viscosity at 80° C. are obtained by reading viscosities at 40° C. and 80° C. in the viscosity/temperature curve. The phase transition temperature is obtained as a temperature at which viscosity becomes 200 mPa·s in the viscosity/temperature curve.

When the drop 2 contains a gelling agent, the drop 2 preferably has a phase transition temperature of 40° C. or more and 70° C. or less. At the phase transition temperature, a sol-gel phase transition is performed. With a phase transition temperature of the drop 2 of 40° C. or more, the viscosity of the drop 2 is rapidly improved after landing on the coating layer 3. Accordingly, it is easy to adjust wetting and spreading of the drop 2. With a phase transition temperature of the drop 2 of 70° C. or less, the drop 2 is less likely to gel when ejected from the drop ejection head 1 usually having a drop temperature of about 80° C. Accordingly, it is possible to stably eject the drop 2.

For example, when the drop 2 is a liquid containing a photopolymerizable compound and is cured by actinic irradiation, the drop 2 may be semi-cured by actinic irradiation. “Semi-cured” indicates a state where the drop 2 is not completely cured, leaving room for further curing, and the drop 2 has a certain degree of flexibility or fluidity. An amount of actinic rays irradiated at this time is, for example, 5% or more and 25% or less with respect to an amount of actinic rays for curing the drop 2 containing a photopolymerizable compound and cured by actinic irradiation.

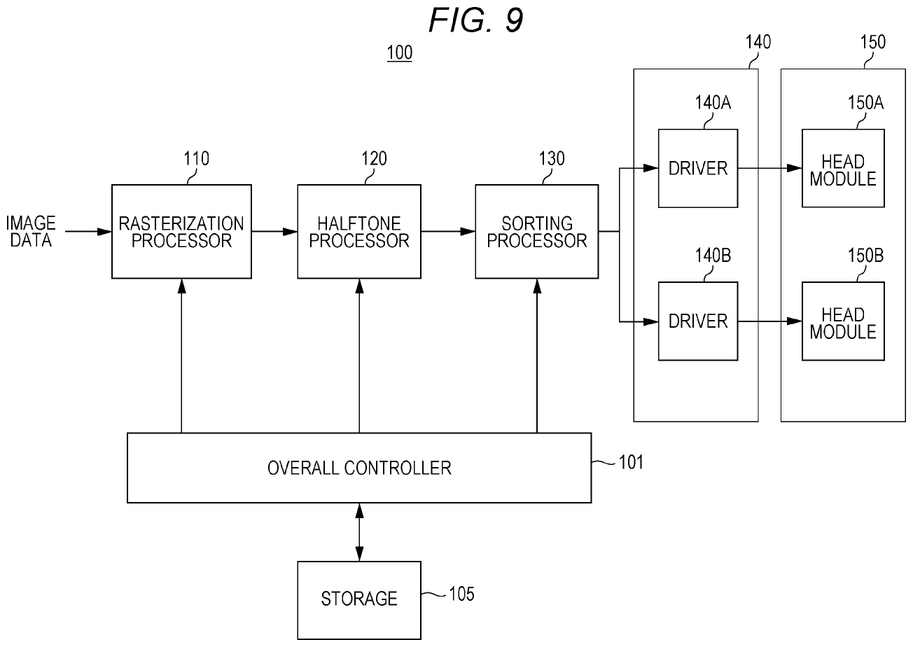

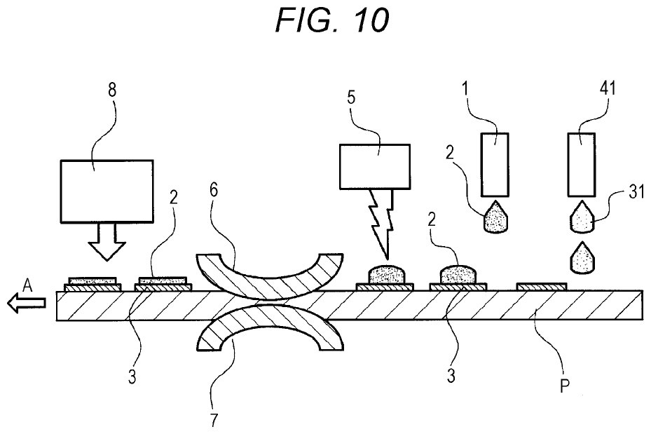

FIG. 9 is a block diagram showing a recording control device of the image forming apparatus according to the first embodiment.

The image forming apparatus includes a recording control device 100 as shown in FIG. 9. Image data is input to the recording control device 100. The image data is converted into bitmap data in a rasterization processor 110 and sent to a halftone processor 120. The halftone processor 120 generates dot data from the bitmap data and sends the data to a sorting processor 130. Through the sorting processor 130, the dot data is sent to head modules 150A and 150B including a plurality of drop ejection heads 1.

For the same color ink in an overlapping region of the adjacent head modules 150A and 150B, the sorting processor 130 sorts by determining which dots are formed by which drop ejection heads 1 of the head modules 150A and 150B. This process is performed for each color ink. The dot data sorted by the sorting processor 130 is sent to either a driver 140A that drives the upstream head module 150A or a driver 140B that drives the downstream head module 150B. The upstream driver 140A drives the upstream head module 150A, and the downstream driver 140B drives the downstream head module 150B.

In other words, the recording control device 100 controls ink ejection toward the recording medium P performed by the plurality of head modules 150A and 150B according to the dot data based on the image data. In an overlapping region, any one of the drop ejection heads 1 corresponding to the two adjacent head modules 150A and 150B is caused to eject ink. In this manner, complementary ink ejection is performed by the drop ejection heads 1 corresponding to the two head modules 150A and 150B.

In the recording control device 100, the rasterization processor 110, the halftone processor 120, and the sorting processor 130 are controlled by an overall controller 101. The overall controller 101 is connected to a storage 105 that stores an image forming program and other information. The image forming method embodied as the performance of the recording control device 100 is carried out when the overall controller 101 executes the image forming program.

The overall controller 101 controls the feeding operation of the recording medium P and controls the coating roller 4, the viscosity improver 5, the rolling roller 6, the counter roller 7, and the curing or drying tool 8.

In this image forming apparatus, the drop 2 at the time of rolling has lower viscosity than the coating layer 3. Accordingly, an amount of drop 2 penetrating into the recording medium P is small, and the drop 2 can be rolled sufficiently, which successfully enables expansion of the drop 2 and enables good fixability of the drop 2 to the recording medium P (the coating layer 3). Furthermore, since the drop 2 is applied on the recording medium P, the drop 2 does not vary in shape and size as in transfer printing from an intermediate transfer body, and also, since the drop 2 is not reversed, it is possible to enable evenness and good glossiness of the surface, which reduces a feeling of relief.

### Second Embodiment

FIG. 10 is a side view showing a configuration of an image forming apparatus according to a second embodiment.

In the image forming apparatus of this embodiment, a coating layer former may be a coating material ejection head 41 that ejects a liquid coating material 31 as shown in FIG. 10. The coating material ejection head 41 has a similar configuration to the drop ejection head 1 and forms a coating layer 3 by ejecting the liquid coating material 31 onto a recording medium P. The coating material ejection head 41 can form the coating layer 3 by applying the coating material 31 to a region where a drop 2 is to be applied. The coating material ejection head 41 forms the coating layer 3 between the recording medium P and the drop 2 by ejecting the coating material 31 prior to the drop 2 to the region where the drop ejection head 1 ejects the drop 2. Even in this case, when the drop 2 is rolled by the rolling roller 6 and the counter roller 7, the drop 2 has lower viscosity than the coating layer 3.

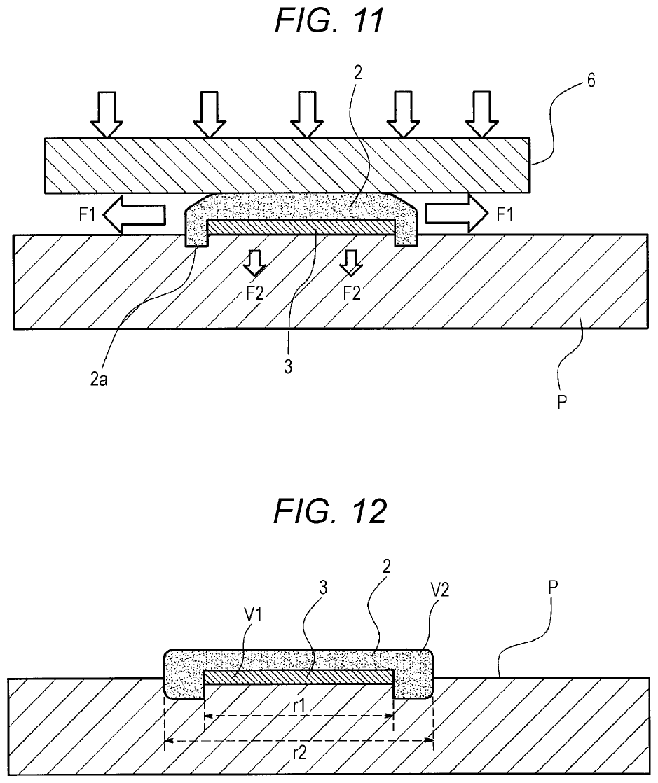

FIG. 11 is a side view showing rolling of a drop on a recording medium provided with a coating layer in a region where the drop is to be applied.

As shown in FIG. 11, in a case where the coating layer 3 is formed in the region where the drop 2 is to be applied, when the drop 2 is rolled by the rolling roller 6 and the counter roller 7, the penetration force F2 of the drop 2 into the coating layer 3 is small, and the force F1 for spreading the drop 2 on the surface of the coating layer 3 is relatively large (F1>F2). When the drop 2 spreads on the surface of the coating layer 3, a peripheral edge 2a of the drop 2 spreads out of the coating layer 3 and reaches the recording medium P provided with no coating layer 3. When the drop 2 reaches the recording medium P provided with no coating layer 3, the drop 2 penetrates into the recording medium P and does not spread further. The peripheral edge 2a of the drop 2 penetrating into the recording medium P enhances fixability of the drop 2 to the recording medium P.

FIG. 12 is a side view showing a relation between volumes of a coating layer formed in a region where a drop is to be applied and the drop.

As shown in FIG. 12, the coating layer 3 formed in the region where the drop 2 is to be applied preferably has a volume (V1) smaller than a volume (V2) of the drop 2 applied and rolled on the coating layer 3.

Making the volume (V1) of the coating layer 3 smaller than the volume (V2) of the drop 2 after rolling (V2>V1) enables penetration of part of the drop 2 (peripheral edge 2a) into the recording medium P. Accordingly, it is possible to sufficiently expand the drop 2 by rolling since most of the drop 2 remains on the coating layer 3, while assuring further fixability to the recording medium P. The drop 2 after rolling has a diameter r2 larger than a diameter r1 of the coating layer 3.

### Third Embodiment

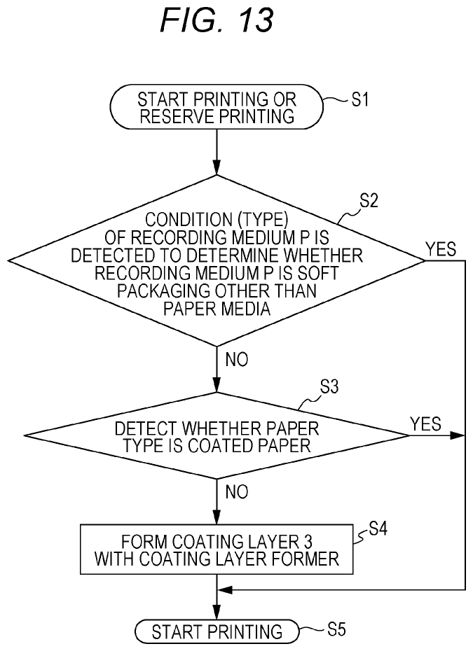

FIG. 13 is a flowchart showing performance of an image forming apparatus of a third embodiment.

The image forming apparatus of this embodiment can control whether or not a coating layer 3 is formed according to conditions of a recording medium P. The conditions of the recording medium P indicate parameters that affect the degree of penetration of a drop 2 into the recording medium P, such as a material of the recording medium P (for example, paper, fabric, and resin) and a structure of the recording medium P (for example, a diameter of a capillary hole), presence or absence of the coating layer 3, a thickness or viscosity of the coating layer 3, and a material of a coating material.

In other words, as shown in FIG. 13, in step S1, an overall controller 101 of a recording control device 100 starts printing or reserves printing, and then, the process proceeds to step S2.

In step S2, a condition (type) of the recording medium P is detected to determine whether the recording medium P is a soft packaging (resin film) other than paper media. A condition of the recording medium P may be detected with an optical sensor or other sensors or may be detected by an input to the overall controller 101. If the recording medium P is a soft packaging other than paper media, the process proceeds to step S5, and if not, the process proceeds to step S3.

In step S3, a paper type of the recording medium P is detected to determine whether the paper type is coated paper. A paper type may be detected with an optical sensor or other sensors or may be detected by an input to the overall controller 101. If the paper type is coated paper, the process proceeds to step S5, and if not, the process proceeds to step S4.

In step S4, to prevent the drop 2 from penetrating into the recording medium P, the coating layer 3 is formed by a coating layer former.

In step S5, printing is started. Here, as described above, the drop 2 is ejected onto the coating layer 3 of the recording medium P (in both cases where the recording medium P is a soft packaging and coated paper) and is brought into semi-cured state where the drop 2 has lower viscosity than the coating layer 3.

### EXAMPLE

Specific Examples of the present invention will now be described together with Comparative Examples, but the present invention is not limited to these Examples.

[Determinate Relation Between Presence or Absence of Coating Layer, Viscosity of Coating Layer, and Viscosity of Drop]

### Example 1

(Printing Conditions)

An ink jet printer manufactured by Konica Minolta Inc. was remodeled to use as an image forming apparatus. A recording medium used was plain paper which easily allows a drop to penetrate. A coating layer including a polymerizable oligomer was formed. The coating layer was formed on a landing surface of a drop and smoothed with a scraper as necessary. The coating layer was formed on a surface of the recording medium at least in a region where a drop is to be landed. The coating layer was set to have a thickness smaller than a thickness of a drop in a formed image, that is, a thickness of 0.5 μm or more and 1.0 μm or less, because the landed drop may penetrate into the coating layer.

As the drop, a UV curable liquid was used. Viscosity of the drop was improved with a UV-LED light source having an emission wavelength of 395 nm. The irradiation intensity was set to 1.5 mW/cm². The drop 2 was rolled by roller rolling at a pressure of 1000 Pa. The drop was fixed with a UV-LED light source having an emission wavelength of 395 nm. The irradiation intensity was set to 5 mW/cm².

(Evaluation of Expansion Ratio and Roundness)

An expansion ratio and roundness of the drop after rolling were evaluated. An expansion ratio affects consumption of a liquid that forms a drop. An expansion ratio is indicated by a ratio of a diameter of a drop after rolling to a diameter of a drop yet to be rolled. A diameter of the drop is derived from statistical data obtained by PIAS2 measurement. Roundness affects quality of a formed image. Roundness is derived from statistical data obtained by PIAS2 measurement.

(Relation Between Expansion Ratio and Liquid Consumption)

With an expansion ratio less than 105% (almost no expansion), the liquid consumption when printing a predetermined amount (page volume) (for example, both sides of B2 paper as many as 1000 sheets) of a predetermined image (for example, a solid image) is regarded as A. On the other hand, with an expansion ratio of 105% or more, the liquid consumption when printing a predetermined amount (for example, both sides of B2 paper as many as 1000 sheets) of a predetermined image (for example, a solid image) is regarded as A′. As shown in [Table 1], the liquid consumption has a relation of A>A′, and setting the expansion ratio to 105% or more reduces the liquid consumption.

TABLE 1

| Expansion | Liquid |
|---|---|
| Ratio | Consumption |
| 105% or | A′ ◯ (few) |
| more | |
| Less | A X (many) |
| than 105% | |

(Relation Between Roundness and Image Quality)

Roundness in a range of 0.9 to 1.4 does not cause poor image quality as shown in [Table 2]. Roundness beyond the above range causes poor image quality. Roundness is preferably in a range of 0.9 to 1.4.

TABLE 2

| Roundness | |
|---|---|
| R | Image Quality |
| 0.9 ≤ R ≤ 1.4 | ◯: No poor |
| | image quality |
| R < 0.9, 1.4 < R | X: Poor image |
| | quality |

The viscosity of the drop before rolling was improved to 1.0×10⁶ (mPa·s). The coating layer was formed on the recording medium, and the coating layer has viscosity of 1.0×10⁷ (mPa·s). [Table 3] shows the results.

### Comparative Example 1-1

An image was formed in a similar manner to Example 1 except that a coating layer was not formed. [Table 3] shows the results.

### Comparative Example 1-2

An image was formed in a similar manner to Example 1 except that a coating layer had viscosity of 1.0×10³ (mPa·s). [Table 3] shows the results.

TABLE 3

| | | Viscosity mPa · s | | | | | |
|---|---|---|---|---|---|---|---|
| | | (after improving | | | | | |
| | | viscosity and before | | | | | |
| | | rolling) | | Drop | | | Image |
| | Coating Layer | Coating | | Expansion | | Liquid | Quality |
| | Presence/Absence | Layer | Drop | Ratio | Roundness | Consumption | Evaluation |
| Example 1 | Presence | 1.0 × 10\hat{ }7 | 5.0 × 10\hat{ }6 | 120% (◯) | ◯ | ◯ | ◯ |
| Comparative | Absence | — | 5.0 × 10\hat{ }6 | 100% (X) | ◯ | X | ◯ |
| Example 1-1 | | | | | | | |
| Comparative | Presence | 1.0 × 10\hat{ }3 | 5.0 × 10\hat{ }6 | 100% (X) | ◯ | X | ◯ |
| Example 1-2 | | | | | | | |

[Evaluation]

### Example 1

A drop subjected to rolling had an expansion ratio of 120%. Roundness of the drop, liquid consumption, and quality of a formed image were all good.

### Comparative Example 1-1

A drop was not expanded by rolling and had an expansion ratio of 100%. Roundness of the drop and quality of a formed image were good, but liquid consumption was poor.

### Comparative Example 1-2

A coating layer had viscosity lower than that of a drop. The drop was not expanded by rolling and had an expansion ratio of 100%. Roundness of the drop and quality of a formed image were good, but liquid consumption was poor.

The above results show that viscosity of a coating layer is preferably larger than that of a drop.

[Determine Optimum Range of Viscosity of Drop and Expansion Ratio of Drop]

### Example 2

An image was formed in a similar manner to Example 1 except that a coating layer was formed on a recording medium, viscosity of the coating layer was 1.0×10⁸ (mPa·s), and viscosity of a drop before rolling was improved to 1.0×10⁶ (mPa·s). [Table 4] shows the results.

### Example 3

An image was formed in a similar manner to Example 2 except that viscosity of a drop before rolling was improved to 1.0×10⁷ (mPa·s). [Table 4] shows the results.

### Comparative Example 2

An image was formed in a similar manner to Example 2 except that viscosity of a drop before rolling was improved to 5.0×10⁵ (mPa·s). [Table 4] shows the results.

### Comparative Example 3

An image was formed in a similar manner to Example 2 except that viscosity of a drop before rolling was improved to 5.0×10⁷ (mPa·s). [Table 4] shows the results.

TABLE 4

| | | Viscosity mPa · s | | | | | |
|---|---|---|---|---|---|---|---|
| | | (after improving | | | | | |
| | | viscosity and before | | | | | |
| | | rolling) | | Drop | | | Image |
| | Coating Layer | Coating | | Expansion | | Liquid | Quality |
| | Presence/Absence | Layer | Drop | Ratio | Roundness | Consumption | Evaluation |
| Example 2 | Presence | 1.0 × 10\hat{ }8 | 1.0 × 10\hat{ }6 | 130% (◯) | ◯ | ◯ | ◯ |
| Example 3 | Presence | 1.0 × 10\hat{ }8 | 1.0 × 10\hat{ }7 | 105% (◯) | ◯ | ◯ | ◯ |
| Comparative | Presence | 1.0 × 10\hat{ }8 | 5.0 × 10\hat{ }5 | 150% (◯) | X | ◯ | X |
| Example 2 | | | | | | | |
| Comparative | Presence | 1.0 × 10\hat{ }8 | 5.0 × 10\hat{ }7 | 100% (X) | ◯ | X | ◯ |
| Example 3 | | | | | | | |

[Evaluation]

### Example 2

A drop subjected to rolling had an expansion ratio of 130%. Roundness of the drop, liquid consumption, and quality of a formed image were all good.

### Example 3

A drop subjected to rolling had an expansion ratio of 105%. Roundness of the drop, liquid consumption, and quality of a formed image were all good.

### Comparative Example 2

A drop subjected to rolling had an expansion ratio of 150%. Liquid consumption was good, but roundness of the drop and quality of a formed image were poor.

### Comparative Example 3

A drop subjected to rolling had an expansion ratio of 100%. Roundness of the drop and quality of a formed image were good, but liquid consumption was poor.

The above results show that a drop after viscosity improvement preferably has viscosity of 1.0×10⁶ to 10⁷ (mPa·s). In addition, it has been confirmed that the coating layer 3 preferably has viscosity of 1.0×10⁷ to 10⁸ (mPa·s) (from Examples 1 to 3).

It has also been confirmed that an expansion ratio of a drop diameter is preferably 105 to 130%. Furthermore, it has been confirmed that an expansion ratio of 120% is most preferable, resulting in stable roundness (from Examples 1 to 3).

[Determine Relation Between Volume of Coating Layer and Volume of Drop]

### Example 4-1

A coating layer was formed in a region where a drop was to be ejected by an inkjet method (spot coating). As a coating material that forms the coating layer, a material containing a photopolymerizable compound and cured by actinic irradiation was used. The coating material applied by an ejection head was irradiated with actinic rays to improve the coating material in viscosity. The coating layer had viscosity of 1.0×10⁷ (mPa·s). The viscosity of the drop before rolling was improved to 1.0×10⁶ (mPa·s). The coating layer had a volume (V1) larger than a volume (V2) of the drop. Other conditions were similar to those in the image formation of Example 1. [Table 6] shows the results.

### Example 4-2

An image was formed in a similar manner to Example 4-1 except that an amount of liquid of coating material that forms a coating layer was reduced and a volume (V1) of the coating layer was smaller than a volume (V2) of a drop. [Table 6] shows the results.

As shown in Table 5, when an amount of drop fixed to a recording medium was 90% or more, 85% or more, 80% or more, or less than 80%, fixability of the drop was evaluated as “⊙” (best), “◯” (good), “Δ” (not good), or “x” (poor), respectively.

TABLE 5
Fixability between Recording Medium and Drop (%)

⊙: 90% or more
◯: 85% or more
Δ: 80% or more
X: less than 80%

TABLE 6

| | | Volume of | | | | | | | |
|---|---|---|---|---|---|---|---|---|---|
| | | Coating | Viscosity mPa · s | | | | | | |
| | | Layer | (after improving | | | | | | Fixability |
| | | (V1) | viscosity and before | | | | | | between |
| | | Volume | rolling) | | Drop | | | Image | Recording |
| | Coating Layer | of Drop | Coating | | Expansion | | Liquid | Quality | Medium |
| | Presence/Absence | (V2) | Layer | Drop | Ratio | Roundness | Consumption | Evaluation | and Drop |
| Example 4-1 | Presence/Partially | V2 < V1 | 1.0 × 10\hat{ }7 | 5.0 × 10\hat{ }6 | 120% (◯) | ◯ | ◯ | ◯ | ◯ |
| | Applied | | | | | | | | |
| Example 4-2 | Presence/Partially | V1 < V2 | 1.0 × 10\hat{ }7 | 5.0 × 10\hat{ }6 | 118% (◯) | ◯ | ◯ | ◯ | ⊚ |
| | Applied | | | | | | | | |

[Evaluation]

### Example 4-1

A drop subjected to rolling had an expansion ratio of 120%. Roundness of the drop, liquid consumption, quality of a formed image, and fixability of the drop to a recording medium were all good.

### Example 4-2

A drop subjected to rolling had an expansion ratio of 118%. Roundness of the drop, liquid consumption, and quality of a formed image were all good. Fixability of the drop to a recording medium was superior to the result of Example 4-1 and was the best.

It has been confirmed that, when a coating layer is formed in a region where a drop is to be ejected, making a volume (V1) of the coating layer smaller than a volume (V2) of the drop enables fixability of the drop to a recording medium to be enhanced without greatly varying an expansion ratio of the drop.

[Determine Relation with Conditions of Recording Medium]

### Example 1

As already described, in Example 1, plain paper was used, and a print was made after a coating layer was formed. Plain paper (non-coated paper with high penetration) having an average capillary hole radius of about 0.6 μm was used. The viscosity of the drop before rolling was improved to 5.0×10⁶ (mPa·s). [Table 7] shows the results.

### Example 5

An image was formed in a similar manner to Example 1 except that coated paper provided with a pre-coating layer was used as a recording medium and that a print was made without a coating layer. As the coated paper (coated paper having low penetration), one having an average capillary hole radius of about 0.06 μm was used. Viscosity of a drop before rolling was improved to 5.0×10⁶ (mPa·s). [Table 7] shows the results.

### Comparative Example 1-1

As already described, in Comparative Example 1-1, an image was formed in a similar manner to Example 1 except that plain paper was used as a recording medium and that a print was made without a coating layer. The viscosity of the drop before rolling was improved to 5.0×10⁶ (mPa·s). [Table 7] shows the results.

### Comparative Example 5

An image was formed in a similar manner to Example 5 except that coated paper provided with a pre-coating layer was used as a recording medium and that a print was made after a coating layer was formed. The viscosity of the drop before rolling was improved to 5.0×10⁶ (mPa·s). [Table 7] shows the results.

### Comparative Example 6

An image was formed in a similar manner to Example 5 except that plain paper was used as a recording medium and that a print was made without a coating layer. Viscosity of a drop before rolling was improved to 5.0×10⁷ (mPa·s). [Table 7] shows the results.

TABLE 7

| | | | Viscosity mPa · s | | | | | | |
|---|---|---|---|---|---|---|---|---|---|
| | | | (after improving | | | | | | Fixability |
| | | Coating | viscosity and before | | | | | | between |
| | | Layer | rolling) | | Drop | | | Image | Recording |
| | | Presence/ | Coating | | Expansion | | Liquid | Quality | Medium |
| | Paper Type | Absence | Layer | Drop | Ratio | Roundness | Consumption | Evaluation | and Drop |
| Example 1 | Plain Paper | Presence | 1.0 × 10\hat{ }7 | 5.0 × 10\hat{ }6 | 120% (◯) | ◯ | ◯ | ◯ | ◯ |
| Example 5 | Coated Paper | Absence | — | 5.0 × 10\hat{ }6 | 120% (◯) | ◯ | ◯ | ◯ | ◯ |
| Comparative | Plain Paper | Absence | — | 5.0 × 10\hat{ }6 | 100% (X) | ◯ | X | ◯ | ⊚ |
| Example 1-1 | | | | | | | | | |
| Comparative | Coated Paper | Presence | 1.0 × 10\hat{ }7 | 5.0 × 10\hat{ }6 | 120% (◯) | ◯ | ◯ | ◯ | ◯ |
| Example 5 | | | | | | | | | |
| Comparative | Plain Paper | Absence | — | 1.0 × 10\hat{ }7 | 100% (X) | ◯ | X | ◯ | ⊚ |
| Example 6 | | | | | | | | | |

[Evaluation]

### Example 1

A drop subjected to rolling had an expansion ratio of 120%. Roundness of the drop, liquid consumption, quality of a formed image, and fixability of the drop to a recording medium were all good.

### Example 5

A drop subjected to rolling had an expansion ratio of 120%. Roundness of the drop, liquid consumption, quality of a formed image, and fixability of the drop to a recording medium were all good.

### Comparative Example 1-1

A drop was not expanded by rolling and had an expansion ratio of 100%. Roundness of the drop and quality of a formed image were good, but liquid consumption was poor. Fixability of the drop to the recording medium was superior to the result of Example 1 and was the best.

### Comparative Example 5

A drop subjected to rolling had an expansion ratio of 120%. Roundness of the drop, liquid consumption, quality of a formed image, and fixability of the drop to a recording medium were all good.

### Comparative Example 6

A drop was not expanded by rolling and had an expansion ratio of 100%. Roundness of the drop and quality of a formed image were good, but liquid consumption was poor. Fixability of the drop to the recording medium was superior to the result of Example 1 and was the best.

A drop is less likely to penetrate into coated paper provided with a pre-coating layer. Accordingly, it has been confirmed that rolling the drop successfully enables expansion of the drop even without a coating layer (Example 5). It has been confirmed that there is no problem with further formation of a coating layer on a pre-coating layer (Comparative Example 5). It has been confirmed that, even though viscosity of a drop is improved, if a coating layer is not formed, the drop cannot be expanded by rolling on plain paper that easily allows the drop to penetrate (Comparative Example 6).

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
a drop applier that applies a drop to a surface of a coating layer formed on a surface of a recording medium;
a viscosity improver that improves viscosity of the drop on the surface of the coating layer; and
a roller that rolls the drop improved in viscosity,
wherein the drop at a time of rolling has lower viscosity than the coating layer.

2. The image forming apparatus according to claim 1, wherein the drop at a time of rolling has a complex viscosity η* of 1.0×10⁶ to 1.0×10⁷ (mPa·s).

3. The image forming apparatus according to claim 1, wherein the coating layer includes a material that is not easily affected by drop penetration.

4. The image forming apparatus according to claim 1, wherein the viscosity improver improves viscosity of the drop by ultraviolet irradiation, heating, or heat absorption.

5. The image forming apparatus according to claim 1, wherein the roller rolls the drop with pressure or heat, or with pressure and heat.

6. The image forming apparatus according to claim 1, wherein, when the drop is rolled by the roller, an interface between the drop and the coating layer has a diameter increased to 105 to 130%.

7. The image forming apparatus according to claim 1, further comprising:
a coating layer former that forms a coating layer on the surface of the recording medium,
wherein, before the drop is applied, the coating layer former forms the coating layer at least in a region where the drop is to be applied by the drop applier.

8. The image forming apparatus according to claim 7, wherein the coating layer former is a coating material ejection head that ejects a liquid coating material and forms the coating layer by applying the liquid coating material to a region where the drop is to be applied.

9. The image forming apparatus according to claim 8, wherein the coating layer has a volume smaller than a volume of the drop applied and rolled on the coating layer.

10. The image forming apparatus according to claim 7, wherein the image forming apparatus controls whether or not the coating layer is formed according to a condition of the recording medium.

11. An image forming method comprising:
applying a drop to a surface of a coating layer formed on a surface of a recording medium;
improving viscosity of the drop on the surface of the coating layer; and
rolling the drop improved in viscosity,
wherein the drop at a time of rolling has lower viscosity than the coating layer.

12. The image forming method according to claim 11, wherein the drop at a time of rolling has a complex viscosity η* of 1.0×10⁶ to 1.0×10⁷ (mPa·s).

13. The image forming method according to claim 11, wherein the coating layer includes a material that is not easily affected by drop penetration.

14. The image forming method according to claim 11, wherein the viscosity of the drop is improved by ultraviolet irradiation, heating, or heat absorption.

15. The image forming method according to claim 11, wherein the drop is rolled with pressure or heat, or with pressure and heat.

16. The image forming method according to claim 11, wherein, when the drop is rolled, an interface between the drop and the coating layer has a diameter increased to 105 to 130%.

17. The image forming method according to claim 11, wherein, before the drop is applied, the coating layer is formed on the surface of the recording medium at least in a region where the drop is to be applied.

18. The image forming method according to claim 17, wherein the coating layer is formed by applying a liquid coating material to a region where the drop is to be applied.

19. The image forming method according to claim 18, wherein the coating layer has a volume smaller than a volume of the drop applied and rolled on the coating layer.

20. The image forming method according to claim 17, wherein whether or not the coating layer is formed is determined according to a condition of the recording medium.
